(19) United States
(12) Patent Application Publication
(10) Pub. No.: US 2014/0246333 A1
(43) Pub. Date: Sep. 4, 2014

(54) METHODS OF CONTROLLING EMISSIONS

(71) Applicant: ECOLAB USA INC., Naperville, IL (US)

(72) Inventors: Rebecca Lee Stiles, Aurora, IL (US); Richard Mimna, Oakdale, PA (US); Bruce A. Keiser, Plainfield, IL (US)

(73) Assignee: ECOLAB USA INC., Naperville, IL (US)

(21) Appl. No.: 13/784,119

(22) Filed: Mar. 4, 2013

(51) Int. Cl. B01D 19/00

(52) U.S. Cl. CPC B01D 19/0084
USPC 205/771; 204/242; 204/230.2; 204/230.8

(57) ABSTRACT

Disclosed herein are methods for controlling mercury emissions, and more particularly, to methods for controlling mercury re-emissions from a wet flue gas desulfurizer by using applied electrochemical potential.

### TECHNICAL FIELD

The present disclosure relates generally to methods for controlling emissions of hazardous air pollutants, and more particularly, to methods for controlling mercury emissions from wet flue gas desulfurizers using applied electrochemical potential.

### BACKGROUND

The Environmental Protection Agency (EPA) recently published the Mercury and Air Toxics Rule (MATS Rule) that will require all electricity generating units (EGUs) that burn fossil fuels to reduce mercury emissions levels. Many of these units currently use or will use wet flue gas desulfurizers (wFGDs) to meet acid gas or SOx emission limits. A wFGD contacts combustion gas with an aqueous alkaline solution. This solution may be composed of magnesium compounds, sodium compounds, and slurries of lime or limestone to capture and neutralize acid gases, such as sulfur dioxide. The aqueous alkaline solution is commonly referred to as “wFGD liquor” or “scrubber liquor.” In a forced oxidation system, oxygen may be introduced into the wFGD liquor to oxidize sulfite to sulfate. In many cases, this forms gypsum (calcium sulfate), as the final byproduct of scrubbing. Other systems may utilize inhibited or natural oxidation scrubbing, which results in sulfite salts or mixed sulfite/sulfate salts as byproduct.

Mercury entering EGUs as a contaminant of the fuel is released during combustion. Combustion gases exiting the boiler may contain mercury in three forms: particulate, oxidized, and elemental. Particulate mercury can be captured by particulate control devices such as electrostatic precipitators (ESPs) and fabric filters (FF). Oxidized mercury is water-soluble and as such, wFGDs can absorb the oxidized mercury from the combustion gas into the liquid phase. Elemental mercury, which is insoluble in water, is difficult to capture using existing air quality control devices. Accordingly, most elemental mercury control measures focus on converting elemental mercury into oxidized mercury. Mechanical methods such as fixed bed catalysts (e.g., SCRs), and chemical additives (e.g., calcium bromide, hydrogen bromide, ammonium chloride) have been developed that oxidize elemental mercury in the gas phase for subsequent capture with a wFGD. The captured mercury leaves the process via wFGD blow down.

As oxidized mercury is water soluble, wFGDs are theoretically capable of capturing nearly 100% of the oxidized mercury in a combustion gas. However, data collected by the Department of Energy (DOE) as well as numerous laboratory and commercial studies have shown lower capture efficiencies. The lower efficiencies are the result of reduction of oxidized mercury to elemental mercury (e.g., Hg²⁺ to Hg⁰) within the wFGD scrubber liquor. For example, one reduction reaction involves the oxidation of sulfite by ionic mercury in the wFGD to provide sulfate and elemental mercury. The result is an increase across the wFGD of elemental mercury content in the scrubbed combustion gas, and thus a decrease in total mercury capture as measured from fossil fuel to stack. This reduction of oxidized mercury in the scrubber and subsequent release is known in the industry as mercury re-emission. The loss in wFGD mercury capture efficiency due to mercury re-emission will prevent some EGUs from meeting the MATS Rule, necessitating installation of additional capital equipment.

Mercury re-emission is currently addressed with addition of sulfur-based additives, both organic and inorganic, or sulfur-based modified inorganics to chelate ionic mercury in the scrubber liquor, or through addition of absorbents such as activated carbon. In all these cases, the additive is introduced into the scrubber at an excess rate that has previously been shown to reduce re-emission. This approach often results in overfeeding of the additives, which in turn leads to increased operating costs and higher waste generation. Furthermore, it is becoming impractical to rely exclusively on existing boiler additives to control mercury oxidation, or injection of large volumes of activated carbon to remove hazardous air pollutants through gas-phase contact.

There is a need in the art for non-chemical based methods of controlling mercury re-emission, which can supplement or replace chemical based approaches of reducing hazardous air pollutant emissions.

### SUMMARY

In one aspect, disclosed is a method for controlling mercury emissions from a combustion gas. The method may include applying an electrochemical potential to a scrubber liquor of a wet flue gas desulpherizer (wFGD). The applied electrochemical potential (Eₐₚₚ) may be a positive electrochemical potential, or a negative electrochemical potential. The applied electrochemical potential (e.g., a positive Eₐₚₚ) may be adjusted to reduce mercury re-emission from the scrubber liquor to a selected level. In certain embodiments, the applied electrochemical potential may be adjusted to reduce mercury re-emission from the scrubber liquor to a level of 20% or less, 10% or less, or 1% or less.

In certain embodiments, the applied electrochemical potential to the scrubber liquor may increase the scrubber liquor potential to at least 0 mV, at least 100 mV, at least 200 mV, at least 300 mV, at least 400 mV, at least 500 mV, at least 600 mV, at least 700 mV, at least 800 mV, at least 900 mV, at least 1000 mV, at least 1200 mV, at least 1300 mV, at least 1400 mV, or at least 1500 mV.

In certain embodiments, the application and/or adjustment of the applied electrochemical potential to the scrubber liquor is automated. The applied electrochemical potential may be adjusted in response to measuring the scrubber solution electrochemical potential.

In certain embodiments, mercury re-emission from the scrubber liquor is controlled solely through the use of applied electrochemical potential. Accordingly, in certain embodiments, little or no mercury re-emission additives are required, as the applied electrochemical potential may be sufficient to reduce mercury re-emission to a desired level.

In certain embodiments, mercury re-emission from the scrubber liquor is controlled through use of applied electrochemical potential in combination with one or more mercury re-emission control additives.

In certain embodiments, the electrochemical potential is applied by at least partially submerging a working electrode, a reference electrode, and at least one auxiliary electrode into the scrubber liquor and applying a selected DC current to the working electrode. The working electrode may be a high surface area reticulated, mesh, or flag electrode. The working electrode may be a stainless steel working electrode. The reference electrode may be a Ag/AgCl reference electrode. The at least one auxiliary electrode may be a stainless steel auxiliary electrode. Each electrode may be coupled to a unit to control power supplied to the electrodes, said unit coupled to a power supply.

In another aspect, disclosed is a wet flue gas desulpherizer (wFGD) adapted with a working electrode, a reference electrode, and at least one auxiliary electrode. Preferably, each electrode is at least partially submerged within the scrubber liquor of the wFGD. The working electrode may be configured to apply an electrochemical potential to the scrubber liquor to control mercury re-emission from the wFGD.

In certain embodiments, each electrode is coupled to a unit to control power supplied to the electrodes, said unit coupled to a power supply. The unit may be a potentiostat or a potential control unit, and the power supply may be a DC current power supply.

In certain embodiments, the working electrode is a mesh, flag, grated, or reticulated stainless steel working electrode. In certain embodiments, the reference electrode is a Ag/AgCl reference electrode. In certain embodiments, the at least one auxiliary electrode is a stainless steel auxiliary electrode. In certain embodiments, one or more of the electrodes are not touching or attached to a metal surface of the wFGD. In certain embodiments, the electrochemical potential is applied directly to the scrubber liquor, rather than through a surface of the wFGD vessel.

The methods and processes are further described herein.

### BRIEF DESCRIPTION OF THE DRAWINGS

FIG. 1 depicts a wet flue gas desulpherizer equipped with a device to apply an electrochemical potential to the scrubber liquor.

FIG. 2 depicts a bench-scale BASi Bulk Electrolysis cell used to investigate the effects of an applied potential to wFGD scrubber water.

FIG. 3 depicts the effect of applying negative and positive electrochemical potentials to a solution of 50 ppb Hg²⁺ in 0.1 M Na₂SO₄ electrolyte solution.

FIG. 4 depicts the effect of applying a negative electrochemical potential to scrubber water from a wFGD.

FIG. 5 depicts the effect of applying a positive electrochemical potential to control chemical reduction of mercury via sulfite ions.

### DETAILED DESCRIPTION

Disclosed herein are methods for controlling mercury emissions from a scrubber process. The methods include applying an electrical potential to a scrubber liquor of a wet flue gas desulpherizer (wFGD) to control mercury re-emissions. Use of applied electrochemical potential offers an alternative to chemistry-based solutions of controlling mercury emissions, and may provide several advantages over currently available technologies. For example, the method may be far less sensitive to swings in operational parameters such as scrubber pH, inlet SO₂ concentrations, and lime feed rates, all which have been observed to cause difficulty in controlling mercury emission via chemical based approaches (e.g., use of calcium bromide based oxidants). The application of a positive electrical potential across a wFGD may provide the added benefit of protection of stainless steel components against corrosion. Other advantages of using applied electrochemical potential to control emissions include smaller equipment, the elimination of the need for large chemical storage vessels, reduction in capital investment, and the abundance of electricity to operate the unit. Mercury and other hazardous air pollutants (HAPs) can be removed from the aqueous solution via complexation onto a sacrificial electrode, thus minimizing generated waste.

### 1. DEFINITION OF TERMS

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present invention. All publications, patent applications, patents and other references mentioned herein are incorporated by reference in their entirety. The materials, methods, and examples disclosed herein are illustrative only and not intended to be limiting.

As used in the specification and the appended claims, the singular forms “a,” “and” and “the” include plural references unless the context clearly dictates otherwise. The terms “comprise(s),” “include(s),” “having,” “has,” “can,” “contain(s),” and variants thereof, as used herein, are intended to be open-ended transitional phrases, terms, or words that do not preclude the possibility of additional acts or structures. The present disclosure also contemplates other embodiments “comprising,” “consisting of” and “consisting essentially of,” the embodiments or elements presented herein, whether explicitly set forth or not.

The term “applied electrochemical potential” or “Eₐₚₚ,” as used herein, refers to the voltage being applied to the working electrode.

The term “open circuit potential” or “E_{oc},” as used herein, refers to the voltage difference measured between a working electrode and a reference electrode when no current is applied.

The term “mercury re-emission,” as used herein, refers to the phenomenon when water-soluble oxidized mercury (Hg²⁺) undergoes chemical reduction to water-insoluble elemental mercury (Hg⁰) in a wet flue gas desulfurization (WFGD) scrubber. It is believed the reduction occurs because of a reaction between mercury ions and sulfite ions present in the WFGD liquor. Because elemental mercury is insoluble in water, it exits the scrubber in the gas-phase. Thus the elemental mercury concentration in the flue gas exiting the scrubber is higher than the elemental mercury concentration entering the scrubber.

The term “percent mercury re-emission,” as used herein, refers to:

$$\% Hg Re \text{-} emission = ( \frac{{Hg}_{outlet}^{0} - {Hg}_{inlet}^{0}}{{Hg}_{Inlet}^{0} - {Hg}_{Inlet}^{0}} ) \times 100 \qquad Equation 1$$

where “outlet” refers to EGU stack gas mercury measurement, “inlet” refers to gas concentrations at the inlet to the wFGD, “0” refers to the concentration of elemental mercury in the gas, and “T” refers to the total concentration of mercury in the gas. The “outlet” measurement may refer to mercury gas measurements made at any location after the gas has exited the wFGD.

The term “percent mercury oxidation,” as used herein, refers to:

$$\% Hg Oxidation = ( \frac{{Hg}_{inlet}^{T} - {Hg}_{inlet}^{0}}{{Hg}_{inlet}^{T}} ) \times 100 \qquad Equation 2$$

where the super- and sub-scripts have the same meaning as defined in Equation 1 above.

The term “percent mercury capture,” as used herein, refers to:

$$\% Hg Capture = ( \frac{{Hg}_{Inlet}^{T} - {Hg}_{outlet}^{T}}{{Hg}_{Inlet}^{T}} ) \times 100 \qquad Equation 3$$

where the super- and sub-scripts have the same meaning as defined in Equation 1 above.

The term “oxidation-reduction potential,” as used herein, refers to the summation of all the oxidation and reduction potentials in a given solution or scrubber liquor. As such, the oxidation-reduction potential varies depending on a liquor composition.

### 2. APPLIED ELECTROCHEMICAL POTENTIAL FOR CONTROLLING MERCURY EMISSION

The methods disclosed relate to controlling mercury emissions from wet flue gas desulpherizers using applied electrochemical potential. In certain embodiments, a negative electrochemical potential may be applied to a wFGD scrubber liquor to increase or “turn on” mercury re-emission. In other embodiments, a positive electrochemical potential may be applied to a wFGD scrubber liquor to decrease or “turn off” mercury re-emission.

Although not wishing to be bound by theory, it is believed that application of a negative electrochemical potential to a scrubber liquor causes ionic mercury in the solution to be reduced to insoluble elemental mercury, which may be subsequently released from solution as elemental mercury gas. It is believed that application of a positive electrochemical potential to a scrubber liquor prevents ionic mercury in the solution from being reduced to elemental mercury, thereby preventing re-emission of elemental mercury from the scrubber liquor.

In certain embodiments, the electric potential of the scrubber liquor may be correlated with a level of mercury re-emission, and may be used to guide application or adjustment of an applied electrochemical potential to the scrubber liquor to reduce mercury re-emission to a selected level. In certain embodiments, the electric potential of a scrubber liquor may be measured, and the applied electrochemical potential adjusted to increase the electric potential of the scrubber liquor, thereby reducing the percent mercury re-emission from the scrubber liquor. In certain embodiments, the electric potential of a scrubber liquor may be measured, and the applied electrochemical potential adjusted to decrease the electric potential of the scrubber liquor, without substantially increasing the percent mercury re-emission from the scrubber liquor.

In certain embodiments, other properties of the scrubber liquor may be correlated to a percent mercury re-emission, and may be continuously or intermittently monitored to guide adjustment of the applied electrochemical potential. In certain embodiments, any combination of electric potential, ionic mercury concentration, oxidation-reduction potential, and sulfide ion concentration may be correlated to a level of mercury re-emission and may be used to monitor the scrubber liquor and guide application and/or adjustment of the applied electrochemical potential.

In certain embodiments, monitoring of the scrubber liquor composition and subsequent adjustment of the applied electrochemical potential, and optionally the rate of addition of a mercury re-emission control additive, may be automated. In certain embodiments, the scrubber liquor electric potential, the ionic mercury concentration, the oxidation-reduction potential, and/or the sulfide ion concentration may be monitored by an automated process, and depending on the measured value(s), the applied electrochemical potential, and optionally the rate of addition of a mercury re-emission control additive, may be automatically adjusted in real time to compensate for changes in the fuel, plant load, and/or scrubber liquor composition, thereby continuously maintaining a desired mercury re-emission level, preferably without over- or under feeding of wFGD with mercury re-emission control additives, if used.

In certain embodiments, the applied electrochemical potential may be selected based on a targeted potential of the scrubber liquor relative to baseline. The scrubber liquor baseline potential may vary widely due to variations in composition. Factors that affect the necessary applied electrochemical potential to target a selected mercury re-emissions level include coal composition, which includes, but is not limited to mercury and sulfur concentration of the coal; halogen content of the coal; the type of fuel (e.g., anthracite, lignite, bituminous or subbituminous); the megawatt size of the plant (e.g., 100 to 1000 MW), or capacity of the plant; the presence of other air quality control devices ahead of the scrubber such as fabric filters or electrostatic precipitators; the application of other flue gas mercury reduction technologies such as activated carbon or inorganic sorbents prior to the scrubber; the application of mercury re-emission control additives in the scrubber; the design type of the scrubber, (e.g., spray tower, chiota also known as a jet bubbler, or horizontal type); the scrubber liquor volume; blow down rate (i.e., the rate at which spent liquor is removed from the scrubber); liquid to gas ratio used in the scrubber; the presences of trays or liquor dispersion techniques such as trays or baffles; the particle size and concentration of lime or limestone being added to the scrubber to neutralize acid gases; the load or demand (i.e., the percent of maximum generating load of the plant); the quality of the water (e.g., concentration of impurities such as cations and anions as well as process byproducts when water is reclaimed from cooling tower blow down); and the relative amount of oxygen introduced into the scrubber slurry for forced oxidation systems. Hence, the starting potential of the scrubber liquor may vary from, for example, −200 mV to +700 mV.

In certain embodiments, the percent mercury re-emission from the scrubber liquor can be reduced by applying a positive electrochemical potential such that the scrubber liquor potential is increased to a value of 0 mV or greater, 100 mV or greater, 200 mV or greater, 300 mV or greater, 400 mV or greater, 500 mV or greater, 600 mV or greater, 700 mV or greater, 800 mV or greater, 900 mV or greater, 1000 mV or greater, 1100 mV or greater, 1200 mV or greater, 1300 mV or greater, 1400 mV or greater, or 1500 mV or greater. In certain embodiments, the percent mercury re-emission from the scrubber liquor can be reduced by providing a scrubber liquor having an applied electrochemical potential from about 0 mV to 1500 mV, 100 mV to 1400 mV, 200 mV to 1300 mV, 300 mV to 1200 mV, 400 mV to 1100 mV, 500 mV to 1000 mV, 600 mV to 900 mV, or 700 mV to 800 mV. In certain embodiments, the percent mercury re-emission from the scrubber liquor can be reduced by providing a scrubber liquor having an applied electrochemical potential from about 0 mV to about 100 mV, about 100 mV to about 200 mV, about 200 mV to about 300 mV, about 300 mV to about 400 mV, about 400 mV to about 500 mV, about 500 mV to about 600 mV, about 600 mV to about 700 mV, about 700 mV to about 800 mV, about 800 mV to about 900 mV, about 900 mV to about 1000 mV, about 1000 mV to about 1100 mV, about 1100 mV to about 1200 mV, about 1200 mV to about 1300 mV, about 1300 mV to about 1400 mV, or about 1400 mV to about 1500 mV. In certain embodiments, the value of potential change may be 50 mV or greater, 100 mV or greater, 200 mV or greater, 300 mV or greater, 400 mV or greater, 500 mV or greater, 600 mV or greater, 700 mV or greater, 800 mV or greater, 900 mV or greater, or 1000 mV or greater.

The percent mercury re-emission may be reduced so that the total mercury emissions leaving the plant's stack is less than the current US EPA-mandated regulation of 1.2 pounds of mercury per trillion British thermal unit (lb/TBtu) or any further regulation.

In certain embodiments, an applied electrochemical potential of 100 mV or greater may correspond to a percent mercury re-emission of 20% or less, 19% or less, 18% or less, 17% or less, 16% or less, 15% or less, 14% or less, 13% or less, 12% or less, 11% or less, 10% or less, 9% or less, 8% or less, 7% or less, 6% or less, 5% or less, 4% or less, 3% or less, 2% or less, 1% or less, or 0%. In certain embodiments, an applied electrochemical potential of 200 mV or greater may correspond to a percent mercury re-emission of 20% or less, 19% or less, 18% or less, 17% or less, 16% or less, 15% or less, 14% or less, 13% or less, 12% or less, 11% or less, 10% or less, 9% or less, 8% or less, 7% or less, 6% or less, 5% or less, 4% or less, 3% or less, 2% or less, 1% or less, or 0%. In certain embodiments, an applied electrochemical potential of 300 mV or greater may correspond to a percent mercury re-emission of 20% or less, 19% or less, 18% or less, 17% or less, 16% or less, 15% or less, 14% or less, 13% or less, 12% or less, 11% or less, 10% or less, 9% or less, 8% or less, 7% or less, 6% or less, 5% or less, 4% or less, 3% or less, 2% or less, 1% or less, or 0%. In certain embodiments, an applied electrochemical potential of 400 mV or greater may correspond to a percent mercury re-emission of 20% or less, 19% or less, 18% or less, 17% or less, 16% or less, 15% or less, 14% or less, 13% or less, 12% or less, 11% or less, 10% or less, 9% or less, 8% or less, 7% or less, 6% or less, 5% or less, 4% or less, 3% or less, 2% or less, 1% or less, or 0%. In certain embodiments, an applied electrochemical potential of 500 mV or greater may correspond to a percent mercury re-emission of 20% or less, 19% or less, 18% or less, 17% or less, 16% or less, 15% or less, 14% or less, 13% or less, 12% or less, 11% or less, 10% or less, 9% or less, 8% or less, 7% or less, 6% or less, 5% or less, 4% or less, 3% or less, 2% or less, 1% or less, or 0%. In certain embodiments, an applied electrochemical potential of 600 mV or greater may correspond to a percent mercury re-emission of 20% or less, 19% or less, 18% or less, 17% or less, 16% or less, 15% or less, 14% or less, 13% or less, 12% or less, 11% or less, 10% or less, 9% or less, 8% or less, 7% or less, 6% or less, 5% or less, 4% or less, 3% or less, 2% or less, 1% or less, or 0%. In certain embodiments, an applied electrochemical potential of 700 mV or greater may correspond to a percent mercury re-emission of 20% or less, 19% or less, 18% or less, 17% or less, 16% or less, 15% or less, 14% or less, 13% or less, 12% or less, 11% or less, 10% or less, 9% or less, 8% or less, 7% or less, 6% or less, 5% or less, 4% or less, 3% or less, 2% or less, 1% or less, or 0%. In certain embodiments, an applied electrochemical potential of 800 mV or greater may correspond to a percent mercury re-emission of 20% or less, 19% or less, 18% or less, 17% or less, 16% or less, 15% or less, 14% or less, 13% or less, 12% or less, 11% or less, 10% or less, 9% or less, 8% or less, 7% or less, 6% or less, 5% or less, 4% or less, 3% or less, 2% or less, 1% or less, or 0%. In certain embodiments, an applied electrochemical potential of 900 mV or greater may correspond to a percent mercury re-emission of 20% or less, 19% or less, 18% or less, 17% or less, 16% or less, 15% or less, 14% or less, 13% or less, 12% or less, 11% or less, 10% or less, 9% or less, 8% or less, 7% or less, 6% or less, 5% or less, 4% or less, 3% or less, 2% or less, 1% or less, or 0%. In certain embodiments, an applied electrochemical potential of 1000 mV or greater may correspond to a percent mercury re-emission of 20% or less, 19% or less, 18% or less, 17% or less, 16% or less, 15% or less, 14% or less, 13% or less, 12% or less, 11% or less, 10% or less, 9% or less, 8% or less, 7% or less, 6% or less, 5% or less, 4% or less, 3% or less, 2% or less, 1% or less, or 0%. In certain embodiments, an applied electrochemical potential of 1100 mV or greater may correspond to a percent mercury re-emission of 20% or less, 19% or less, 18% or less, 17% or less, 16% or less, 15% or less, 14% or less, 13% or less, 12% or less, 11% or less, 10% or less, 9% or less, 8% or less, 7% or less, 6% or less, 5% or less, 4% or less, 3% or less, 2% or less, 1% or less, or 0%. In certain embodiments, an applied electrochemical potential of 1200 mV or greater may correspond to a percent mercury re-emission of 20% or less, 19% or less, 18% or less, 17% or less, 16% or less, 15% or less, 14% or less, 13% or less, 12% or less, 11% or less, 10% or less, 9% or less, 8% or less, 7% or less, 6% or less, 5% or less, 4% or less, 3% or less, 2% or less, 1% or less, or 0%. In certain embodiments, an applied electrochemical potential of 1300 mV or greater may correspond to a percent mercury re-emission of 20% or less, 19% or less, 18% or less, 17% or less, 16% or less, 15% or less, 14% or less, 13% or less, 12% or less, 11% or less, 10% or less, 9% or less, 8% or less, 7% or less, 6% or less, 5% or less, 4% or less, 3% or less, 2% or less, 1% or less, or 0%. In certain embodiments, an applied electrochemical potential of 1400 mV or greater may correspond to a percent mercury re-emission of 20% or less, 19% or less, 18% or less, 17% or less, 16% or less, 15% or less, 14% or less, 13% or less, 12% or less, 11% or less, 10% or less, 9% or less, 8% or less, 7% or less, 6% or less, 5% or less, 4% or less, 3% or less, 2% or less, 1% or less, or 0%. In certain embodiments, an applied electrochemical potential of 1500 mV or greater may correspond to a percent mercury re-emission of 20% or less, 19% or less, 18% or less, 17% or less, 16% or less, 15% or less, 14% or less, 13% or less, 12% or less, 11% or less, 10% or less, 9% or less, 8% or less, 7% or less, 6% or less, 5% or less, 4% or less, 3% or less, 2% or less, 1% or less, or 0%.

In certain embodiments, an applied electrochemical potential is applied by inserting a high surface area working electrode (e.g., a reticulated stainless steel electrode) into a wFGD solution to control the potential of the entire solution. In order to control the potential of a solution, the high surface area working electrode may be necessary, such as a reticulated, mesh, or flag electrode. Accordingly, in certain embodiments, the electrochemical potential is applied directly to the scrubber liquor solution with a high surface area working electrode, rather than applying the potential to the metal walls of the scrubber, as application to the metal walls may not be effective to control the potential of the entire scrubber liquor solution.

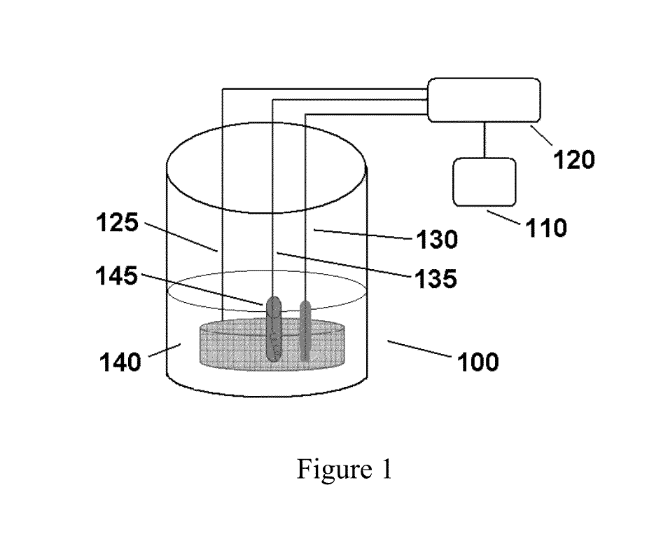

FIG. 1 shows one exemplary embodiment for applying an electrochemical potential to a wFGD to control mercury emission. A DC current power supply 110 provides the power for the technology, which power is controlled using a potentiostat or a potential control unit 120. The power supply 110 and the unit 120 are electrically coupled to electrodes 125, 130, and 135. Specifically, the unit and power supply are electrically coupled to a mesh, flag, grated, or reticulated stainless steel working electrode 125, a reference electrode 130 (typically Ag/AgCl but not necessarily), and at least one auxiliary electrode 135 (also called a counter electrode or anode) placed within the scrubber liquor 140 of the vessel of scrubber 100.

The working electrode 125 may be a large working electrode made of stainless steel construction with a mesh, flag, grated or reticulated design so that there is a high surface area. The working electrode is preferably immersed in the scrubber liquor 140 at all times. The potential of the working electrode controls the degree of completion of an electrolytic process. A stable reference electrode 130 is necessary, and may be a large silver/silver chloride (Ag/AgCl) electrode, but may be comprised of other suitable materials. The reference electrode 130 is preferably immersed in the scrubber liquor 140 at all times. The at least one auxiliary electrode 135 may be a large electrode constructed of stainless steel. However, the auxiliary electrode may not require the large surface area needed for the working electrode 125. The auxiliary electrode 135 is preferably immersed in the scrubber liquor 140 at all times. Preferably, the auxiliary electrode 135 is placed in a separate compartment isolated from the working electrode compartment by a separator 145 (a glass frit or a membrane) to ensure a uniform current distribution across the surface of the working electrode.

In controlled potential experiments, the potential of the working electrode 125 is maintained constant with respect to the reference electrode 130. It is controlled using the potentiostat or potential control unit 120. Using the potential control unit, the desired electrochemical potential can be applied directly to the working electrode to control mercury re-emission levels.

### 3. MERCURY EMISSION CONTROL ADDITIVES

In certain embodiments, applied electrochemical potential to control mercury re-emission may be used in combination with other mercury emission control technologies. In certain embodiments, one or more mercury re-emission control additives be used in combination with applied electrochemical potential.

In certain embodiments, when using a mercury re-emission control additive to control mercury re-emission in combination with applied electrochemical potential, the rate of addition of additive may be adjusted based on measured electric potential of the wFGD scrubber liquor, ionic mercury concentration in the wFGD scrubber liquor, changes in the wFGD scrubber liquor oxidative reduction potential, and/or sulfide ion concentration in the wFGD scrubber liquor.

In certain embodiments, the ionic mercury concentration in a scrubber liquor may be measured, and the rate of addition of a mercury re-emission control additive increased to reduce the ionic mercury concentration, thereby reducing the percent mercury re-emission from the scrubber liquor. In certain embodiments, the ionic mercury concentration of a scrubber liquor may be measured, and the rate of addition of a mercury re-emission control additive decreased while maintaining an ionic mercury concentration, thereby maintaining the percent mercury re-emission from the scrubber liquor without using excess mercury re-emission control additive.

In certain embodiments, the oxidation-reduction potential of a scrubber liquor may be measured, and the rate of addition of a mercury re-emission control additive increased to reduce the ORP, thereby reducing the percent mercury re-emission from the scrubber liquor. In certain embodiments, the oxidation-reduction potential of a scrubber liquor may be measured, and the rate of addition of a mercury re-emission control additive decreased to increase the ORP to an acceptable level to maintain the percent mercury re-emission from the scrubber liquor without using excess mercury re-emission control additive.

In certain embodiments, the sulfide ion concentration in a scrubber liquor may be measured, and the rate of addition of a mercury re-emission control additive increased to increase the sulfide concentration, thereby reducing the percent mercury re-emission from the scrubber liquor. In certain embodiments, the sulfide concentration of a scrubber liquor may be measured, and the rate of addition of a mercury re-emission control additive decreased to decrease the sulfide concentration while maintaining a percent mercury re-emission from the scrubber liquor without using excess mercury re-emission control additive.

Mercury re-emission control additives that can be used with the methods of the invention include any additive suitable to reduce and/or prevent mercury re-emission from combustion processes, and in particular, scrubber liquors.

In certain embodiments, the mercury re-emission control additive may be a poly-dithiocarbamic compound (e.g., MerControl 8034, also referred to herein as “poly-DTC”), or another sulfur-containing additive such as sodium sulfide, sodium hydrosulfide, sodium bisulfide, or a poly-sulfide.

In certain embodiments, the mercury re-emission control additive may be diethyldithiocarbamate or a sodium salt thereof. In certain embodiments, the mercury re-emission control additive may be dimethyldithiocarbamate or a sodium salt thereof.

In certain embodiments, the mercury re-emission control additive may be an inorganic poly-sulfide or blend, such as PRAVO, a product from Vosteen.

In certain embodiments, the mercury re-emission additive may be a sodium or calcium salt of 1,3,5-triazine-2,4,6(1H,3H,5H)-trithione (also referred to as trimercapto-5-triazine), such as TMT-15, a product from Degussa.

In certain embodiments, the mercury re-emission control additive may be an activated carbon, such as disclosed in U.S. Pat. No. 7,727,307 B2.

In certain embodiments, the mercury re-emission control additive may be a dithiol, a dithiolane, or a thiol having a single thiol group and either an oxygen or a hydroxyl group. Suitable dithiols include, but are not limited to, 2,3-dimercaptopropanol, dimercaptosuccinic acid, and 1,8-octanedithiol. Suitable dithiolanes include, but are not limited to, 1,2-dithiolane-3-valeric acid and 2-methyl 1,3-dithiolane. Suitable thiols include, but are not limited to, mercaptoacetic acid and sodium salts thereof.

In certain embodiments, a combination of mercury re-emission controlled additives may be used. In one preferred embodiment, the mercury re-emission control additive comprises a poly-dithiocarbamic compound

a. Ethylene Dichloride Ammonia Polymer Containing Dithiocarbamate Groups

The mercury re-emission control additive may be a water-soluble ethylene dichloride ammonia polymer having a molecular weight of from 500 to 10,000, and containing from 5 to 55 mole % of dithiocarbamate salt groups to prevent re-emission of mercury across a wFGD.

The polymer may be prepared by the reaction of ethylene dichloride and ammonia to provide a polyamine or polyimine. The polyamine or polyimine may have a molecular weight range of 500-100,000. In a preferred embodiment, the molecular weight may be 1,500 to 10,000, with the most preferred molecular weight range being 1,500 to 5,000.

The dithiocarbamate groups of the polymers may be introduced by the reaction of the polyamines or polyimines with carbon disulfide to produce polydithiocarbamic acid or their salts. Such reaction is preferably carried out in a solvent such as water or alcohol at a temperature of from 30° C. and 100° C. for periods of time ranging between 1 and 10 hours. Good conversion may be obtained at temperatures between 40° and 70° C. for 2 to 5 hours.

The mole % of dithiocarbamate salt groups in the finished polymer may be within the range of 5 to 55%, 20 to 40 mole %, or 25 to 30 mole %. The salts include, but are not limited to, alkaline and alkali earth such as sodium, lithium, potassium or calcium.

The finished polymer may be applied to a combustion process at a ratio of 1:1 to 2000:1 weight copolymer to weight of mercury being captured. One preferred ratio may be from 5:1 to 1000:1 more preferably from 5:1 to 500:1.

b. Acrylic-x and Alkylamine Polymer

The mercury re-emission control additive may be a composition comprising a polymer derived from at least two monomers: acrylic-x and an alkylamine, wherein said acrylic-x has the following formula:

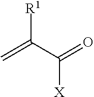

wherein X=OR, OH and salts thereof, or NHR² and wherein R¹ and R² is H or an alkyl or aryl group, wherein R is an alkyl or aryl group, wherein the molecular weight of said polymer is between 500 to 200,000, and wherein said polymer is modified to contain a functional group capable of scavenging one or more compositions containing one or more metals.

The metals can include zero valent, monovalent, and multivalent metals. The metals may or may not be ligated by organic or inorganic compounds. Also, the metals can be radioactive and nonradioactive. Examples include, but are not limited to, transition metals and heavy metals. Specific metals can include, but are not limited to: copper, nickel, zinc, lead, mercury, cadmium, silver, iron, manganese, palladium, platinum, strontium, selenium, arsenic, cobalt and gold.

The molecular weight of the polymers can vary. For example, the target species/application for the polymers can be one consideration. Another factor can be monomer selection. Molecular weight can be calculated by various means known to those of ordinary skill in the art. For example, size exclusion chromatography, as discussed in the examples below can be utilized. When molecular weight is mentioned, it is referring to the molecular weight for the unmodified polymer, otherwise referred to as the polymer backbone. The functional groups that are added to the backbone are not part of the calculation. Thus the molecular weight of the polymer with the functional groups can far exceed the molecular weight range. In one embodiment, the molecular weight of the polymer is from 1,000 to 16,000. In another embodiment, the molecular weight of said polymer is from 1,500 to 8,000.

Various functional groups can be utilized for metal scavenging. The following phraseology would be well understood by one of ordinary skill in the art: wherein said polymer is modified to contain a functional group capable of scavenging one or more compositions containing one or more metals. More specifically, the polymer is modified to contain a functional group that can bind metals. In one embodiment, the functional group contains a sulfide containing chemistry. In another embodiment, the functional group is a dithiocarbamate salt group. In another embodiment, the functional groups are at least one of the following: alkylene phosphate groups, alkylene carboxylic acids and salts thereof, oxime groups, amidooxime groups, dithiocarbamic acids and salts thereof, hydroxamic acids, or nitrogen oxides.

The molar amounts of the functional group relative to the total amines contained in the unmodified polymer can vary as well. For example, the reaction of 3.0 molar equivalents of carbon disulfide to a 1.0:1.0 mole ratio acrylic acid/TEPA copolymer, which contains 4 molar equivalents of amines per repeat unit after polymerization, will result in a polymer that is modified to contain 75 mole % dithiocarbamate salt group. In other words, 75% of the total amines in the unmodified polymer have been converted to dithiocarbamate salt groups.

In one embodiment, the polymer may have between 5 to 100 mole % of the dithiocarbamate salt group. In a further embodiment, the polymer has from 25 to 90 mole % of the dithiocarbamate salt group. In yet a further embodiment, the polymer has from 55 to 80 mole % of the dithiocarbamate salt group.

Monomer selection will depend on the desired polymer. In one embodiment, the alkylamine is at least one of the following: an ethyleneamine, a polyethylenepolyamine, ethylenediamine (EDA), diethylenetriamine (DETA), triethylenetetraamine (TETA), tetraethylenepetamine (TEPA) and pentaethylenehexamine (PEHA). In another embodiment, the acrylic-x is at least one of the following: methyl acrylate, methyl methacrylate, ethyl acrylate, and ethyl methacrylate, propyl acrylate, and propyl methacrylate. In another embodiment, the acrylic-x is at least one of the following: acrylic acid and salts thereof, methacrylic acid and salts thereof, acrylamide, and methacrylamide.

The molar ratio between monomers that make up the polymer, especially acrylic-x and alkylamine can vary and depend upon the resultant polymer product that is desired. The molar ratio used is defined as the moles of acrylic-x divided by the moles of alkylamine. In one embodiment, the molar ratio between acrylic-x and alkylamine is from 0.85 to 1.5. In another embodiment, the molar ratio between acrylic-x and alkylamine is from 1.0 to 1.2. Various combinations of acrylic-x and alkylamines are encompassed by this invention as well as associated molecular weight of the polymers.

In one embodiment, the acrylic-x is an acrylic ester and the alkylamine is PEHA or TEPA or DETA or TETA or EDA. In a further embodiment, the molar ratio between acrylic-x and alkylamine is from 0.85 to 1.5. In yet a further embodiment, the molecular weight can encompass ranges: 500 to 200,000, 1,000 to 16,000, or 1,500 to 8,000. In yet a further embodiment, the acrylic ester can be at least one of the following: methyl acrylate, methyl methacrylate, ethyl acrylate, and ethyl methacrylate, propyl acrylate, and propyl methacrylate, which is combined with at least one of the alklyamines, which includes PEHA or TEPA or DETA or TETA or EDA. In yet a further embodiment, the resulting polymer is modified to contain the following ranges of dithiocarbamate salt groups: 5 to 100 mole %, 25 to 90 mole %, or 55 to 80 mole %.

In another embodiment, the acrylic-x is an acrylic amide and the alkylamine is TEPA or DETA or TETA or EDA. In a further embodiment, the molar ratio between acrylic-x and alkylamine is from 0.85 to 1.5. In yet a further embodiment, the molecular weight can encompass ranges: 500 to 200,000, 1,000 to 16,000, or 1,500 to 8,000. In yet a further embodiment, the acrylic amide can be at least one or a combination of acrylamide and methacrylamide, which is combined with at least one of the alklyamines, which includes PEHA or TEPA or DETA or TETA or EDA. In yet a further embodiment, the resulting polymer is modified to contain the following ranges of dithiocarbamate salt groups: 5 to 100 mole %, 25 to 90 mole %, or 55 to 80 mole %.

In another embodiment, the acrylic-x is an acrylic acid and salts thereof and the alkylamine is PEHA or TEPA or DETA or TETA or EDA. In a further embodiment, the molar ratio between acrylic-x and alkylamine is from 0.85 to 1.5. In yet a further embodiment, the molecular weight can encompass ranges: 500 to 200,000, 1,000 to 16,000, or 1,500 to 8,000. In yet a further embodiment, the acrylic acid can be at least one or a combination of acrylic acid or salts thereof and methacrylic acid or salts thereof, which is combined with at least one of the alklyamines, which includes TEPA or DETA or TETA or EDA. In yet a further embodiment, the resulting polymer is modified to contain the following ranges of dithiocarbamate salt groups: 5 to 100 mole %, 25 to 90 mole %, or 55 to 80 mole %.

Additional monomers can be integrated into the polymer backbone made up of constituent monomers acrylic-x and alkylamine. A condensation polymer reaction scheme can be utilized to make the basic polymer backbone chain. Various other synthesis methods can be utilized to functionalize the polymer with, for example, dithiocarbamate and/or other non-metal scavenging functional groups. One of ordinary skill in the art can functionalize the polymer without undue experimentation.

In certain embodiments, the composition can be formulated with other polymers such as a water soluble ethylene dichloride ammonia polymer having a molecular weight of from 500 to 100,000 which contains from 5 to 55 mole % of dithiocarbamate salt groups. In one embodiment, the molecular weight of the polymer is from 1,500 to 10,000 and contains 15 to 50 mole % of dithiocarbamate salt groups. In a preferred embodiment, the molecular weight of the polymer is from 1,500 to 5,000 and contains 30 to 55 mole % of dithiocarbamate salt groups.

In certain embodiments, the composition can be formulated with other small molecule sulfide precipitants such as sodium sulfide, sodium hydrosulfide, TMT-15® (sodium or calcium salts of trimercapto-S-triazine), dimethyldithiocarbamate, and/or diethyldithiocarbamate.

c. Dosage

The dosage of the disclosed mercury re-emission control additives may vary as necessitated to reduce or prevent mercury re-emission, and depending upon the level of electrochemical potential applied. The dosage amounts can be selected based on a desired ionic mercury concentration, change in ORP, and/or sulfide concentration in the scrubber liquor, which correspond to a percent mercury re-emission. The dosages may be reduced by relying more on applied electrochemical potential to control mercury re-emission.

Process medium quality and extent of process medium treatment are a couple of factors that can be considered by one of ordinary skill in the art in selecting dosage amount. A jar test analysis is a typical example of what is utilized as a basis for determining the amount of dosage required to achieve effective metals removal in the context of a process water medium, e.g. wastewater.

In one embodiment, the amount of mercury re-emission control additive for effectively removing metals from contaminated waters may be within the range of 0.2 to 2 moles of dithiocarbamate per mole of metal, or 1 to 2 moles of dithiocarbamate per mole of metal contained in the water. According to one embodiment, the dosage of metal removal polymer required to chelate and precipitate 100 ml of 18 ppm soluble copper to about 1 ppm or less was 0.011 gm (11.0 mg) of polymer. The metal polymer complexes formed are self-flocculating and quickly settle. These flocculants are easily separated from the treated water.

In the context of applying the polymer to a gas system, such as a flue gas, the polymer can be dosed incrementally and capture rates for a particular metal, e.g. such as mercury, can be calculated by known techniques in the art. In certain embodiments, a mercury re-emission control additive, such as a water-soluble ethylene dichloride ammonia polymer with dithiocarbamate salt groups, may be applied to a scrubber liquor at a ratio of 1:1 to 2000:1 weight of polymer to weight of mercury being captured. One preferred dosage ratio is from 5:1 to 1000:1, more preferably from 5:1 to 500:1.

### 4. APPLICATIONS

Methods of the present invention can be used in any process in which it is desirable to remove mercury from a flue gas. For example, the methods of the present invention can be used in waste incineration plants (e.g., domestic waste, hazardous waste, or sewage sludge incineration plants), power stations (e.g., bituminous coal-fired, or lignite-fired power stations), other plants for high-temperature processes (e.g., cement burning), and high-temperature plants co-fired with waste or combined (multistage) high-temperature plants (e.g., power stations or cement rotary kilns having an upstream waste pyrrolysis or waste gasification

Methods of the present invention can be used in processes of any dimension. The methods can be used in processes having a flue gas volumetric flow rate of 15×10³ m³ S.T.P. db/h, for example for sewage sludge incineration, or of 50×10³ m³ S.T.P. db/h, for example in hazardous waste incineration plants, or of 150×10³ m³ S.T.P. db/h, for example in domestic waste incineration, and also in large power stations having, for example, 2-3×10⁶ m³ S.T.P. db/h.

The methods can be used with any scrubbers currently used in the industry, including spray towers, jet bubblers, and co-current packed towers. These types of particulate control devices are provided as examples and are not meant to represent or suggest any limitation. In certain embodiments, a configuration according to FIG. 1 may be adapted to provide a selected electrochemical potential to a scrubber.

When used, mercury re-emission control additives may be introduced into a scrubber and thereby into the scrubber liquor via several routes. For example, a mercury re-emission control additive may be added to a virgin limestone or lime slurry prior to addition to a scrubber, to the recirculation loop of a scrubber liquor, or to a “low solids” return to a scrubber from the scrubber purge stream. The addition of a mercury re-emission control additive, such as a polydithiocarbamic acid compound, can be made in any suitable location in a scrubber process, wholly or fractionally (i.e. a single feed point or multiple feed points), including but not limited to the make-up water for the lime or limestone slurry or the scrubber liquor.

In certain embodiments, the mercury re-emission control additive may be added to a wet scrubber via a “low solids” liquor return. A portion of the liquor is usually continuously removed from the scrubber for the purpose of separating reaction byproducts from unused lime or limestone. One means of separation that is currently used is centrifugation. In this process the scrubber liquor is separated into a “high solids” and “low solids” stream. The high solids stream is diverted to wastewater processing. The low solids fraction returns to the wet scrubber and can be considered “reclaimed” dilute liquor. The mercury re-emission control additives, such as polydithiocarbamic acid compounds, can conveniently be added to the reclaimed low solids stream prior to returning to the scrubber.

In certain embodiments, the mercury re-emission control additive may be added to the wet scrubber via a “virgin liquor.” Virgin liquor is the water-based dispersion of either lime or limestone prior to exposure to flue gas and is used to add fresh lime or limestone while maintaining the scrubber liquor level and efficiency of the wet FGD. This is prepared by dispersing the lime or limestone in water. Here the mercury re-emission control additive, such as a polydithiocarbamic acid compound, can be added either to the dispersion water or the virgin liquor directly.

In certain embodiments, the mercury re-emission control additive, such as a polydithiocarbamic compound, may be added to scrubber liquor injected directly into the flue gas prior to the scrubber for the purpose of controlling relative humidity of the flue gas or its temperature.

The scrubber liquors referred to herein may be water-based dispersions of calcium carbonate (limestone) or calcium oxide (lime) used in a wet Flue Gas Scrubber to capture SOx emissions. The liquor may also contain other additives such as magnesium and low-molecular weight organic acids, which function to improve the sulfur capture. One example of such an additive is a mixture of low-molecular weight organic acids known as dibasic acid (DBA). DBA consists of a blend of adipic, succinic, and glutaric acids. Each of these organic acids can also be used individually. In addition, another low-molecular weight organic acid that can be used to improve sulfur capture in a wet scrubber is formic acid. Finally, the scrubber liquor may also contain byproducts of the interaction between the lime or limestone and sulfur species, which leads to the presence of various amounts of calcium sulfite or calcium sulfate. The scrubber liquor may include the make-up liquor, return liquor, the reclaimed liquor, virgin liquor, and/or liquor injected directly into flue gasses.

### 5. EXAMPLES

The foregoing may be better understood by reference to the following examples, which are presented for purposes of illustration and are not intended to limit the scope of the invention.

### Example 1

### Applied Electrochemical Potential

Data from the laboratory and the field demonstrate the usefulness of applied electrochemical potential for preventing mercury re-emission and thus lowering overall mercury emissions at coal-fired power plants.

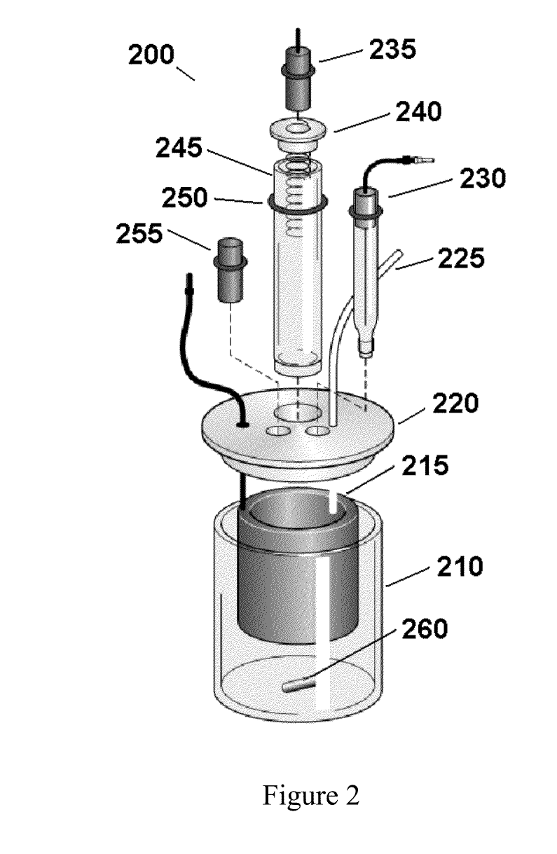

To investigate the effects of an applied potential to FGD scrubber water on the bench-scale, the electrochemical technique of Bulk Electrolysis (also known as Controlled Potential Coulometry) was implemented with the setup as shown in FIG. 2. The electrochemical cell 200 includes a glass cell 210 (e.g., a 75 mL water jacketed cell), a working electrode 215 (e.g. a 2205 steel flag electrode fashioned from 40×40 mesh gauge woven wire cloth made of 2205 stainless steel with a wire diameter of 0.008 inches), a teflon cap 220, a teflon gas tube 225, a reference electrode 230 (e.g., a Ag/AgCl reference electrode), an auxiliary electrode 235 (e.g., a coiled 23 cm platinum wire auxiliary electrode), an auxiliary electrode bushing 240, an auxiliary electrode chamber 245 (e.g., fritted glass tube), an O-ring 250, a port plug 255, and a stir bar 260.

The BASi bulk electrolysis cell, the coiled 23 cm platinum wire auxiliary electrode, and the Ag/AgCl reference electrode were purchased from BASi (West Lafayette, Ind.). The working electrode was a home-built 2205 steel flag electrode fashioned from 40×40 mesh gauge woven wire cloth made of 2205 stainless steel having a wire diameter of 0.008 inches. The wire cloth was purchased from the Belleville Wire Cloth Co., Inc. (Cedar Grove, N.J.).

In controlled potential experiments, the potential of the working electrode is maintained constant with respect to the reference electrode. The potential of the working electrode controls the degree of completion of the electrolytic process, and a stable reference electrode is necessary. The auxiliary electrode must be placed in a separate compartment isolated from the working electrode compartment by a separator (a glass frit) to ensure a uniform current distribution across the surface of the working electrode.

Experiments were run using a Gamry Instruments Reference 600 potentiostat with DC105 DC Corrosion Techniques Software. All experiments were performed using 50 mL of solution with 0.1 M Na₂SO₄ electrolyte, stirred at 600 rpm. Samples were subjected to a variety of electrochemical potentials.

To analyze the amount of mercury being volatilized out of the solution, the electrochemical cell of FIG. 2 was connected via the Teflon tubing to an Ohio Lumex RA915+ Zeeman spectrometer. The rest of the cell was sealed off to ensure the volatilized mercury exited through the tubing and into the spectrometer. The spectrometer analyzes the mercury gas via atomic absorption. It is preceded by an impinger with 1.0M stannous chloride (SnCl₂) in 5% HCl to ensure that all of the mercury entering the analyzer is reduced to the elemental phase.

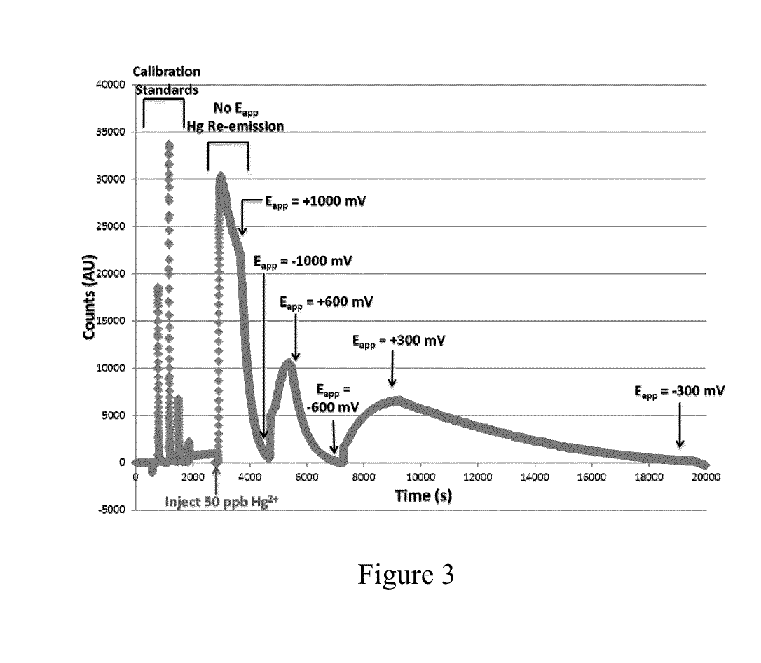

FIG. 3 shows data collected in the laboratory in which negative and positive electrochemical potentials were applied to an electrolyte solution (0.1 M sodium sulfate, Na₂SO₄, in deionized water) containing 50 parts per billion (ppb) ionic mercury (Hg²⁺) (prepared from 100 ppm stock solution of Hg(NO₃)₂ in 5% HNO₃). Mercury emission measurements were made in absorbance units versus time over the course of the experiment.

FIG. 3 demonstrates the ability to “turn on” and “turn off” mercury re-emission by applying negative and positive electrochemical potentials, respectively. Specifically, it shows that after injection 50 ppb Hg²⁺ (at t=3000 s), there is significant mercury re-emission observed with no applied electrochemical potential to the solution. Once a positive electrochemical potential of Eₐₚₚ=+1000 mV is applied to the solution, the mercury re-emission is effectively stopped, and the mercury emissions go to zero. Applying a negative electrochemical potential of Eₐₚₚ=−1000 mV (at t=4500 s) leads to the mercury re-emission phenomenon and an increased mercury emission measured. Applying a positive electrochemical potential of Eₐₚₚ=+600 mV leads to the mercury re-emission being turned “off” and mercury emissions returning to zero. Applying a smaller negative potential of Eₐₚₚ=−600 mV leads to mercury re-emission occurring and an increase in mercury emissions measured, however the magnitude of the mercury emissions are lower than when a more negative potential was applied (Eₐₚₚ=−1000 mV). Applying a smaller positive electrochemical potential of Eₐₚₚ=+300 mV leads to a decrease of mercury emissions back to zero but the decrease takes longer than when a more positive potential was applied. Applying an even smaller negative electrochemical potential of Eₐₚₚ=−300 mV does not result in mercury re-emission in this case. The magnitude of the re-emission is concluded to be directly proportional to the magnitude (or absolute value) of the applied negative electrochemical potential. The speed in which mercury re-emission is turned off is concluded to be directly proportional to the magnitude (or absolute value) of the applied positive electrochemical potential.

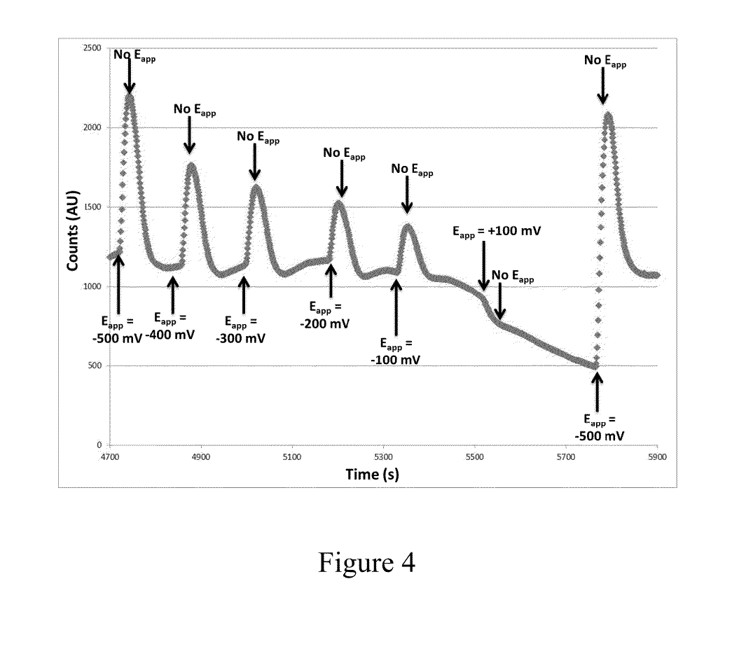

FIG. 4 shows results from applying a negative electrochemical potential to scrubber liquor collected from an actual wFGD containing approximately 100 ppb ionic mercury (Hg²⁺). For the experiment, the wFGD liquor was allowed to sit in a bucket so that the solids settled to the bottom and the supernatant was sampled off the top of the bucket. The soluble mercury in the supernatant had been previously measured to be ca. 100 ppb. No volatile mercury was observed in the Ohio Lumex spectrometer at that concentration, so an additional 900 ppb Hg²⁺ (prepared from 100 ppm stock solution of Hg(NO₃)₂ in 5% HNO₃) was added to the solution to give 1 ppm total mercury concentration. As can be seen in FIG. 4, when a negative electrochemical potential is applied to the solution, mercury is re-emitted as elemental mercury and measured in the gas-phase in counts (absorbance units) using a gas-phase mercury analyzer. The magnitude of the negative applied potential is directly proportional to the amount of mercury re-emitted in the liquor. For example, the mercury measured in the gas-phase when an electrochemical potential of −500 mV is applied to the solution is greater than the mercury measured in the gas-phase when an electrochemical potential of −400 mV is applied to the solution. To stop the mercury re-emission, the applied negative electrochemical potential is turned off, effectively applying a potential of 0 mV. The last peak in FIG. 4 repeats the applied negative potential of −500 mV and gets the same results as the first time this potential was applied. This was done as a control to prove that the magnitude of the applied potential is directly related to the amount of mercury re-emitted.

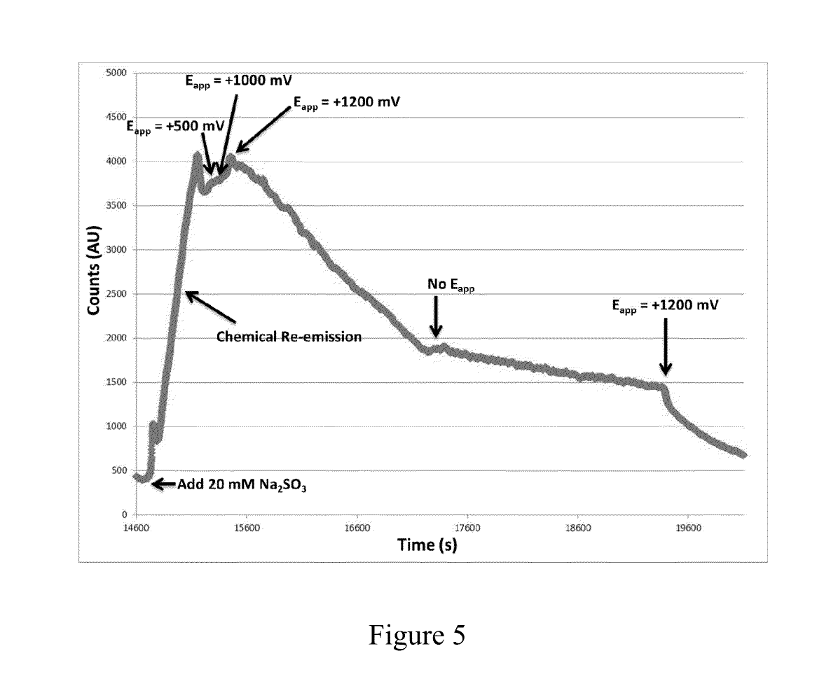

FIG. 5 shows results from applying an electrochemical potential to scrubber liquor collected from an actual wFGD, containing approximately 100 ppb ionic mercury (Hg²⁺). For the experiment, the wFGD liquor was allowed to sit in a bucket so that the solids settled to the bottom and the supernatant was sampled off the top of the bucket. The soluble mercury in the supernatant had been previously measured to be ca. 100 ppb. No volatile mercury was observed in the Ohio Lumex spectrometer at that concentration, so an additional 900 ppb Hg²⁺ (prepared from 100 ppm stock solution of Hg(NO₃)₂ in 5% HNO₃) was added to the solution to give 1 ppm total mercury concentration. Additionally, Na₂SO₄ was added to the wFGD liquor to give a concentration of 0.1 M to enhance conductivity for the electrochemistry experiments. To investigate the role of chemical reduction of Hg²⁺ in comparison to electrochemical reduction, 20 ppm of Na₂SO₃ was added to the wFGD liquor.

In FIG. 5, it can be seen that when Na₂SO₃ is injected into the WFGD scrubber liquor, chemical reduction of mercury occurs and re-emission is measured in absorbance units. When a positive potential of Eₐₚₚ=+500 mV is applied to the solution, re-emission remains uncontrolled. An even more positive potential of Eₐₚₚ=+1000 mV is applied to the solution, and again re-emission is not controlled. Finally a very positive potential of Eₐₚₚ=+1200 mV is applied to the solution and the chemically induced mercury re-emission decreases toward zero. Prior to reaching zero, the applied potential is turned off and the mercury emissions begin to stabilize again until the positive electrochemical potential of Eₐₚₚ=+1200 mV is turned back on and the mercury re-emission decreases until the total mercury emissions reach baseline conditions. FIG. 5 shows that the high concentration of sulfite ions (SO₃²⁻) causes significant mercury re-emission and that this chemical re-emission can be controlled by a positive applied potential. In contrast to FIG. 3, this experiment indicates that chemical reduction, as opposed to electrochemical reduction, requires a larger magnitude applied positive electrochemical potential to control the mercury re-emission phenomenon.

The foregoing examples demonstrate that applied electrochemical potential, individually or in combination with mercury re-emission control additives, may be used to reduce mercury re-emissions.

Any ranges given either in absolute terms or in approximate terms are intended to encompass both, and any definitions used herein are intended to be clarifying and not limiting. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges (including all fractional and whole values) subsumed therein.

Furthermore, the invention encompasses any and all possible combinations of some or all of the various embodiments described herein. Any and all patents, patent applications, scientific papers, and other references cited in this application, as well as any references cited therein, are hereby incorporated by reference in their entirety.

What is claimed is:

1. A method of controlling mercury re-emission from a combustion process, the method comprising applying a positive electrochemical potential to a scrubber liquor of a wet flue gas desulpherizer (wFGD).

2. The method of claim 1, wherein the percent mercury re-emission from the scrubber liquor is reduced to 10% or less.

3. The method of claim 1, wherein the percent mercury re-emission from the scrubber liquor is reduced to 1% or less.

4. The method of claim 1, wherein the applied electrochemical potential to the scrubber liquor increases the scrubber liquor potential to 0-1500 mV.

5. The method of claim 4, wherein the increase in the scrubber liquor potential correlates to a decrease in mercury re-emission from the scrubber liquor to a value of 20% mercury re-emission or less.

6. The method of claim 4, wherein the increase in the scrubber liquor potential correlates to a decrease in mercury re-emission from the scrubber liquor to a value of 10% mercury re-emission or less.

7. The method of claim 4, wherein the increase in the scrubber liquor potential correlates to a decrease in mercury re-emission from the scrubber liquor to a value of 1% mercury re-emission or less.

8. The method of claim 1, wherein application and adjustment of the applied electrochemical potential to the scrubber liquor is automated.

9. The method of claim 1, further comprising use of a mercury re-emission control additive in combination with the applied electrochemical potential.

10. The method of claim 9, wherein the mercury re-emission control additive is a polydithiocarbamic compound.

11. The method of claim 1, wherein the positive electrochemical potential is applied by at least partially submerging a working electrode, a reference electrode, and at least one auxiliary electrode into the scrubber liquor and applying a selected DC current to the working electrode.

12. The method of claim 11, wherein the working electrode is a high surface area reticulated, mesh, or flag electrode.

13. The method of claim 12, wherein the working electrode is a stainless steel working electrode.

14. The method of claim 11, wherein the reference electrode is a Ag/AgCl reference electrode.

15. The method of claim 11, wherein the at least one auxiliary electrode is a stainless steel auxiliary electrode.

16. The method of claim 11, wherein each electrode is coupled to a unit to control power supplied to the electrodes, said unit coupled to a power supply.

17. A wet flue gas desulpherizer (wFGD) adapted with a working electrode, a reference electrode, and at least one auxiliary electrode, each electrode at least partially submerged within a scrubber liquor of the wFGD, the working electrode configured to apply an electrochemical potential to the scrubber liquor to control mercury re-emission from the wFGD.

18. The wFGD of claim 17, wherein each electrode is coupled to a unit to control power supplied to the electrodes, said unit coupled to a power supply.

19. The wFGD of claim 18, wherein the unit is a potentiostat or a potential control unit, and the power supply is a DC current power supply.

20. The wFGD of claim 17, wherein the working electrode is a mesh, flag, grated, or reticulated stainless steel working electrode.

21. The wFGD of claim 17, wherein the reference electrode is a Ag/AgCl reference electrode.

22. The wFGD of claim 17, wherein the at least one auxiliary electrode is a stainless steel auxiliary electrode.
